(19) United States
(12) Patent Application Publication
(10) Pub. No.: US 2026/0273501 A1
(43) Pub. Date: Sep. 17, 2026

(54) SYSTEMS AND METHODS FOR MAKING SYNGAS

(71) Applicant: JBK EXTRACTIONS LLC, Thornton, CO (US)

(72) Inventor: James E. Klepper, Thornton, CO (US)

(21) Appl. No.: 19/165,885

(22) PCT Filed: Mar. 17, 2023
(86) PCT No.: PCT/US2023/015451

§ 371 Date: Sep. 16, 2025

(51) Int. Cl. B01J 19/24; B01J 6/00; B01J 19/00; C01B 3/34

(52) U.S. Cl. CPC B01J 19/245; B01J 6/008; B01J 19/0013; C01B 3/34; B01J 2219/00087; B01J 2219/00157; C01B 2203/0233; C01B 2203/0811; C01B 2203/0838

(57) ABSTRACT

Systems and methods for making syngas using a carbonaceous material, including organic material and/or polymeric material such as ground tire, wood, coal, and the like. The systems and methods may heat the carbonaceous material before syngas formation and be configured to use less oxygen than conventional syngas synthesis systems. Systems and methods including maintaining the mixture of gases at an elevated temperature while flowing gases along a tortuous reaction zone having a nonlinear path downstream of a reaction area.

### FIELD OF THE INVENTION

This application is a 371 National Stage of International Patent Application No. PCT/US2023/015451, filed on Mar. 17, 2023, the disclosure of which is incorporated by reference herein in its entirety.

### FIELD OF THE INVENTION

The present invention relates to systems and methods for making syngas that includes primarily carbon monoxide and hydrogen such as for use in fuel.

### BACKGROUND OF THE INVENTION

Syngas, or synthesis gas, is a fuel gas mixture often produced using a process known as gasification that produces primarily carbon monoxide (CO) and hydrogen (H₂), and may include carbon dioxide (CO₂), methane (CH₄), other gases (e.g., hydrocarbons), and particulate matter (e.g., ash and tar). Although syngas can be formed under various conditions, gasification involves reacting a carbon source with steam at elevated temperatures, generally in the absence of oxygen. Conventional gasification systems may enable or cause elevated temperatures for reacting the carbon source with steam by combusting a fuel source with oxygen at or near the point of gasification. However, as will be discussed further below, it may be preferable to minimize the amount of oxygen added for combustion to reduce impact of excess oxygen on the gasification processed. The elevated temperature causes the carbon source to react with the steam to partially oxidize the carbon source, forming carbon monoxide and hydrogen, for example. Examples of reactors that are particularly suited for use in the formation of syngas via gasification are disclosed in Klepper, U.S. Pat. No. 6,863,878 and Klepper, U.S. Pat. No. 8,349,046. These reactors combine a carbon source, such as char, with steam at elevated temperatures to produce a syngas.

Gasification may be understood by dividing the process into two discrete stages. In the first stage of gasification, there are four main reactions involving the carbon source in a gasification system, all of which are reversible depending on the concentration of products, reagents, and temperature within the system.

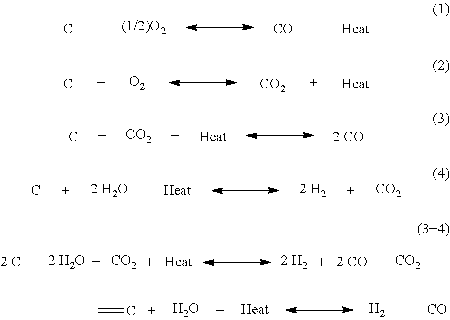

First, a carbon source may be partially oxidized in the presence of oxygen to form carbon monoxide in an exothermic sub-stoichiometric reaction. Second, a carbon source may be fully oxidized in the presence of oxygen gas in an exothermic stoichiometric reaction. Third, in a Boudouard reaction, the carbon source material may be oxidized with carbon dioxide to form carbon monoxide gas in a reversible endothermic reaction. Because this reaction is endothermic, an elevated temperature can reduce the reverse reaction formation of carbon (i.e., coking or sooting) and carbon dioxide from carbon monoxide. Fourth, the carbon source material may be oxidized with water (e.g., steam) to produce hydrogen gas and carbon dioxide in a reversible endothermic reaction. Together, the third and fourth reactions can be added together to show the stoichiometric relationship between the carbon source material and water forming hydrogen gas and carbon monoxide in endothermic reactions.

In the second stage of gasification, two reversible reactions not directly involving the carbon source may take place changing the relative concentrations of the above gases.

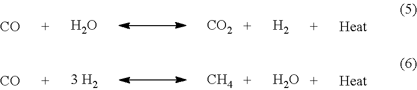

In the fifth reaction, carbon monoxide is oxidized with water (e.g., steam) to produce hydrogen gas and carbon dioxide in a reversible exothermic reaction. In the sixth reaction, carbon monoxide is reduced with hydrogen gas to produce methane and water in a reversible exothermic reaction.

Generally speaking, it is preferrable to form a syngas having a higher proportional volume of carbon monoxide and hydrogen gas and a lower proportional volume of other syngas components-especially carbon dioxide, methane, and other hydrocarbons. Carbon dioxide and methane are known greenhouse gases that often must be sequestered from the remaining syngas product to purify the syngas product. Implementing an additional purification step, such as carbon capture to remove carbon dioxide from the syngas product, increases the costs of syngas formation. Additionally, having a syngas primarily including hydrogen and carbon monoxide can be more easily used as a reagent in a downstream process. One such downstream process to produce liquid hydrocarbons from syngas components is outlined below:

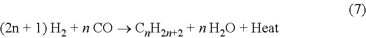

In the seventh reaction, also known as the Fischer-Tropsch process, a mixture of hydrogen gas and carbon monoxide can be converted into one or more alkanes and water via an exothermic reaction. Generally speaking, it is preferrable to have a molar ratio of hydrogen to carbon monoxide greater than 3:1 (i.e., n=1), which would produce primarily methane, because higher ratios are well suited for producing longer hydrocarbons that are often more useful as fuels such as, for example, diesel fuels.

The production of methanol from materials other than natural gas or coal, such as from syngas components like H₂, CO, CO₂, and H₂O, is also desirable at least because methanol is an important feed stock for the production of methanol to gas (MTG) processes. Examples of reactions for producing methanol from syngas components, are shown below:

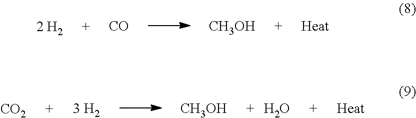

In the eighth reaction, a mixture of hydrogen and carbon monoxide gases having a 2:1 ratio can be converted to methanol in an exothermic reaction. In the ninth reaction, a mixture of hydrogen and carbon dioxide having a 3:1 ratio can be converted to methanol and water in an exothermic reaction. Accordingly, it may be preferrable to produce a syngas having a higher concentration of hydrogen and carbon monoxide over carbon dioxide to provide a syngas that is better suited to serve as a feedstock in MTG processes such as those shown above.

In a conventional system and method for producing syngas from mixing a carbon source with steam and air, it is difficult to maintain the optimal reaction temperature that preferentially produces hydrogen gas and carbon monoxide while minimizing both an amount of undesirable byproducts formed and an amount of oxygen added to the system—in either case, the efficiency of the syngas formation reaction is reduced. If the syngas reaction temperature is too low, the amount of undesirable byproducts and carbon dioxide formed increases. These undesirable byproducts primarily include compounds such as, tars (e.g., aromatic or polyaromatic carbon compounds) and other hydrocarbons. The formation of these unwanted byproducts, especially those tar compounds having between 18 and 40 carbon atoms per unit, may spoil the catalysts used to promote the partial oxidation of the carbon source to syngas. This reduces yields. Low temperatures can also cause the Boudouard reaction (3) described above to favor the formation of carbon dioxide and carbon (e.g., coke) over carbon monoxide. This is not desirable at least because a syngas containing a higher proportional volume of carbon monoxide are preferred over a syngas containing a higher proportional volume of carbon dioxide. Moreover, as carbon is formed in this process, it may deposit onto a downstream process such as, for example, a Fischer-Tropsch catalyst. This would cause serious damage that may not be easily reversed to revitalize the catalyst. In the system for producing syngas disclosed in Klepper, U.S. Pat. No. 8,349,046, generally speaking, a syngas is produced having an amount of carbon dioxide between 15-30% by volume of the syngas is typically formed. In exchange for producing a relatively higher than desirable volume of carbon dioxide, the system generally produces a lower amount of hydrocarbons, typically about 5% or less of total syngas by volume.

A conventional way to increase the temperature in the system is to add an excess of oxygen to combustion with the fuel and/or to the syngas reaction. However, as the oxygen concentration is increased, the syngas reaction produces more carbon dioxide at the expense of the more desirable carbon monoxide. As shown in reactions (1) and (2) above, increasing the amount of oxygen in a syngas reaction will favor reaction (2), producing carbon dioxide, over reaction (1), producing carbon monoxide. In the system for producing syngas disclosed in Klepper, U.S. Pat. No. 6,863,878, generally speaking, a syngas is produced having (1) an amount of hydrogen and carbon monoxide collectively between 20-50% by volume of the syngas, (2) an amount of carbon dioxide between 10-20% by volume of the syngas, and (3) an amount of hydrocarbon volume much higher than the system mentioned above with the remainder gas volume composing of light aromatics (e.g., tars, benzene, toluene).

Accordingly, there is a need for systems and methods for producing syngas that minimize the production of both undesirable byproducts and carbon dioxide while producing proportionally larger volumes of more useful products.

### SUMMARY

Embodiments of the present invention overcomes the shortcomings and drawbacks of reactors for formation of syngas. While the invention will be described in connection with certain embodiments, it will be understood that the invention is not limited to these embodiments. On the contrary, the invention includes all alternatives, modifications and equivalents as may be included within the spirit and scope of the present invention.

One aspect of the invention is a system for forming a syngas including a volatilization zone configured to receive a carbonaceous material and heat the carbonaceous material to a temperature effective to volatilize gas from the carbonaceous material; a combustion zone downstream of the volatilization zone configured to be coupled to a source of fuel, a source of oxygen, and a source of steam and to combust fuel with oxygen to produce heat; a horizontal reaction zone downstream from the combustion zone and configured to react steam from the source of steam and the volatilized gas to produce syngas; a tortuous reaction zone downstream from the horizontal reaction zone and configured to receive and react steam and the volatilized gas to produce syngas; and a furnace including an interior wall that defines a heated volume, wherein at least a portion of the tortuous reaction zone is within the heated volume.

In one embodiment of the system, at least a portion of the volatilization zone is within the heated volume.

In one embodiment of the system, the tortuous reaction zone has a pathlength greater than or equal to 40 feet and less than or equal to 400 feet.

In one embodiment of the system, the furnace is kept at a temperature greater than or equal to 1,900° F. and less than or equal to 2,300° F.

In one embodiment of the system, the furnace further comprises a fan configured to circulate air within the externally heated area.

In one embodiment of the system, the system further includes a carbon feed system having an inlet, being upstream from the volatilization zone, and being configured to receive the carbonaceous material in the inlet and convey the carbonaceous material to the volatilization zone.

In one embodiment of the system, the system further includes a residence chamber downstream from the tortuous reaction zone and configured to receive the syngas, steam, volatilized gas, combusted fuel, and oxygen and separate the syngas from at least one byproduct formed during the syngas reaction; a recovery tank configured to receive the at least one byproduct; and a quench zone downstream from and in material communication with the residence chamber, wherein the quench zone is configured to cool the syngas for removal from the system. In a further embodiment of the above system, the system further includes a pathway connecting the recovery tank to the furnace, wherein the furnace is configured to receive the at least one byproduct to use as fuel to heat the heated volume. In a still further embodiment of the above system, the at least one byproduct includes a material selected from the group consisting of ash and char.

In another embodiment wherein the system includes a residence chamber downstream from the tortuous reaction zone and configured to receive the syngas, steam, volatilized gas, combusted fuel, and oxygen and separate the syngas from at least one byproduct formed during the syngas reaction; a recovery tank configured to receive the at least one byproduct; and a quench zone downstream from and in material communication with the residence chamber, wherein the quench zone is configured to cool the syngas for removal from the system, the system further includes a heat exchanger configured to receive water and/or steam and remove heat from the syngas, wherein the heat exchanger is in thermal communication but not material communication with at least one of the residence chamber, the horizontal reaction zone, and the heated volume. In a further embodiment of the above system, the heat exchanger is configured to supply at least a portion of the steam used in the syngas reaction to the combustion zone.

Another aspect of the invention is a method for producing syngas. The method includes heating a carbonaceous material to a temperature effective to volatilize a gas therefrom; combusting a mixture of fuel and oxygen to generate heat; heating a mixture of steam and the volatilized gas with the heat from combusting in a reaction area to form syngas; and flowing the mixture of steam and the volatilized gas from the reaction area along a non-linear pathway from the reaction area toward a recovery tank at which syngas is collected; wherein during flowing along the non-linear pathway, heating the mixture of steam and the volatilized gas to a temperature effective to form additional syngas.

In one embodiment of the method, the nonlinear pathway has a path length greater than or equal to 40 feet and less than or equal to 400 feet.

In one embodiment of the method, the mixture of steam and the volatilized gas within the reaction area and the nonlinear pathway is kept at a temperature greater than or equal to 1,900° F. and less than or equal to 2,300° F.

In one embodiment of the method, the method further includes quenching the syngas and the additional syngas for removal. In a further embodiment of the above method, the syngas and the additional syngas are maintained at a temperature above the Boudouard carbon formation range prior to quenching.

In one embodiment of the method, the method further includes capturing heat from at least one of the syngas and the additional syngas; and using the captured heat to heat an area where at least one of the syngas or the additional syngas is formed without being in material communication with the area.

In one embodiment of the method, the method further includes capturing at least one byproduct formed during the syngas reaction; and burning the at least one byproduct to produce heat for use during flowing of the steam and the volatilized gas. In a further embodiment of the above method, the at least one byproduct includes a material selected from the group consisting of ash and char. In another further embodiment of the above method, burning provides heat for heating the mixture of steam and volatilized gas during flowing along the non-linear pathway.

In one embodiment of the method, the method further includes adding an amount of excess oxygen not combusted with the fuel prior to heating the mixture of steam and volatilized gas to form syngas, wherein combusting the mixture of fuel and oxygen to generate heat includes adding an amount of oxygen and an amount of fuel in a ratio configured for stoichiometric combustion of the amount of fuel, wherein heating the mixture of steam and the volatilized gas heated to form syngas further includes heating a mixture of volatilized gas and the amount of excess oxygen to form syngas, wherein the ratio between the amount of excess oxygen and the amount of oxygen is less than or equal to 0.1:1.

In one embodiment of the method, the method further includes adding an amount of excess oxygen not combusted with the fuel prior to heating the mixture of steam and volatilized gas to form syngas, wherein combusting the mixture of fuel and oxygen to generate heat includes adding an amount of oxygen and an amount of fuel in a ratio configured for stoichiometric combustion of the amount of fuel, wherein heating the mixture of steam and the volatilized gas heated to form syngas further includes heating a mixture of volatilized gas and the amount of excess oxygen to form syngas, wherein the ratio between the amount of excess oxygen atoms and the carbon atoms of the carbonaceous material is less than or equal to 0.1:1.

In one embodiment of the method, combusting the mixture of fuel and oxygen to generate heat includes adding an amount of oxygen and an amount of fuel in a ratio configured for stoichiometric combustion, wherein any oxygen added in excess of what would be necessary to achieve stoichiometric combustion would define excess oxygen, and wherein no excess oxygen is added.

In one embodiment of the method, the syngas and the additional syngas collectively include an amount of hydrogen gas and an amount of carbon monoxide gas, and wherein the combined amount of hydrogen gas and carbon monoxide gas accounts for between 40-80% by total volume of the combined syngas and additional syngas.

In one embodiment of the method, the syngas and the additional syngas collectively include and amount of carbon dioxide gas, and wherein the amount of carbon dioxide gas accounts for less than or equal to 25% by volume of the combined syngas and additional syngas.

In one embodiment of the method, the syngas and additional syngas collectively include an amount of hydrocarbons, and wherein the amount of hydrocarbons accounts for less than or equal to 10% by volume of the combined syngas and additional syngas.

In one embodiment of the method, the syngas and additional syngas formed include an amount of hydrogen gas and an amount of carbon monoxide gas, and wherein the ratio of hydrogen gas to carbon monoxide gas within the combined syngas and additional syngas is greater than or equal to 2:1.

### BRIEF DESCRIPTION OF THE DRAWINGS

The accompanying drawings, which are incorporated in and constitute a part of this specification, illustrate embodiments of the invention and, together with the general description given above, and the detailed description given below, serve to explain the principles of embodiments of the invention. Similar reference numerals are used to indicate similar features throughout the various figures of the drawings.

FIG. 1 is a simplified flow chart of a system for making syngas in accordance with an embodiment of the invention.

FIG. 2 is a schematic, partial cross-sectional, side elevational view of a system for making syngas in accordance with an embodiment of the invention.

FIG. 3 is an enlarged cross-sectional view of a combustion nozzle of a syngas reactor of FIG. 2.

FIG. 4 is a cross-sectional view taken at lines 4-4 of FIG. 2.

FIG. 5 is a schematic, partial cross-section, side elevational view of a system for making syngas in accordance with an embodiment of the invention.

### DETAILED DESCRIPTION OF EMBODIMENTS OF THE INVENTION

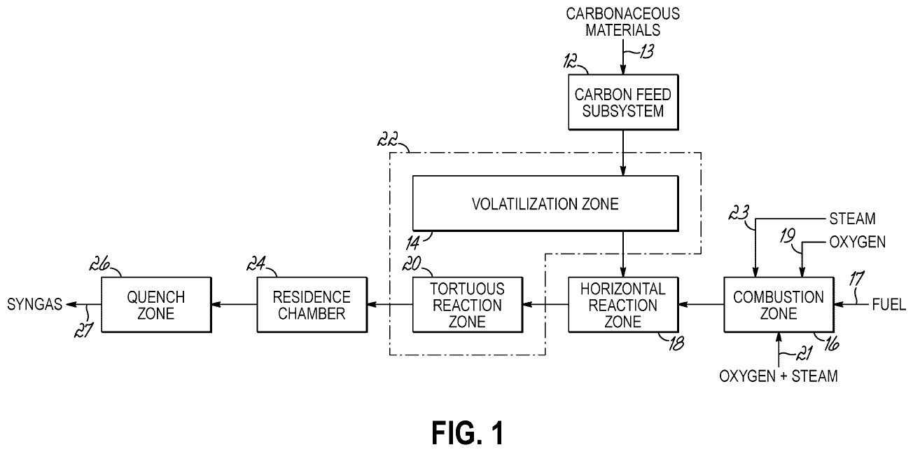

FIGS. 1-5 illustrate systems for making syngas 10 in accordance with embodiments of the invention. In particular and with reference to FIG. 1, in one embodiment, the system 10 includes numerous subsystems or zones coupled to one another and each having a role in the formation of syngas by reacting carbonaceous feed materials and/or reactant carbon with oxygen and/or steam. The subsystems and zones are generally indicated in FIG. 1 by dashed boxes. The boxes are not limiting and are merely to aid the description of the exemplary embodiment of the system 10 and the related method. The arrangement and functions of the subsystems and zones may facilitate production of syngas with (1) a larger proportional volume of more useful products (e.g., carbon monoxide and hydrogen), (2) a smaller proportional volume of carbon dioxide, (3) a smaller proportional volume of hydrocarbons (e.g., tars), and/or (4) a higher molar ratio of hydrogen gas to carbon monoxide. In one embodiment, syngas formation may be improved by, at least in part, producing a syngas having an amount of carbon monoxide and hydrogen collectively between 40-50% by volume of the syngas. In an alternate embodiment, syngas formation may be improved by, at least in part, producing a syngas having an amount of carbon dioxide less than or equal to 10% by volume of the syngas. In another alternate embodiment, syngas production may be improved by, at least in part, producing a syngas having an amount of hydrocarbons less than or equal to 5% by volume of the syngas. In yet another alternate embodiment, syngas formation may be improved by, at least in part, producing a syngas having a molar ratio of hydrogen to carbon monoxide greater than or equal to 2:1, or alternatively greater than or equal to 3:1. In one embodiment, syngas formation may be improved by, at least in part, producing a syngas meeting one or more requirements selected from the group consisting of having an amount of hydrogen and carbon monoxide collectively between 40-50%, having an amount of an amount of carbon dioxide less than or equal to 10%, having an amount of hydrocarbons less than or equal to 5% by volume of the syngas, and having a ratio of hydrogen to carbon monoxide of greater than or equal to 2:1. The amount of hydrogen and carbon monoxide collectively formed during the syngas reaction may be modified by changing the amount of excess oxygen added to the system and/or by otherwise modifying the temperature of the syngas reaction in the system 10. In one such embodiment, the amount of excess oxygen added to the system is less than or equal to 10% when compared to the amount of oxygen necessary for stoichiometric combustion of the fuel. In a further embodiment, the temperature of the system 10 during syngas formation is maintained at a temperature sufficient to produce an amount of hydrocarbons less than or equal to 5% and produce an amount of hydrogen and carbon monoxide collectively between 40-50% by volume of the syngas while maintaining excess oxygen below 10% when compared to the amount of oxygen necessary for stoichiometric combustion.

As referred to herein, “Material communication” means that materials within the section(s) described are able to mix with each other. For example, material communication may include reactants and/or products from one section being able to travel downstream to another section. This includes but is not limited to gases, liquids, solids, or any other phase of matter that may exist within the system 10.

“Thermal communication” means that heat can transfer between the sections without necessarily requiring material communication. Thermal communication includes, but is not limited to, conduction, convection, radiation, or other means of transferring heat energy. For example, thermal communication includes heat conduction across a barrier which limits or prohibits material communication. This includes but is not limited to heat transfer between two gases that are separated by a vessel wall, such as in a heat exchanger.

As used herein, “between X and Y” and “between X-Y” when describing a range of values means that the value is greater than or equal to X and less than or equal to Y. For example, a temperature between 700° F. and 3000° F. means that the temperature is greater than or equal to 700° F. and less than or equal to 3000° F.

Generally, with continued reference to FIG. 1, carbonaceous feed materials are introduced into a carbon feed subsystem 12 at arrow 13. The carbonaceous feed materials pass through a volatilization zone 14 whereat volatilized gases and/or char are produced from the carbonaceous materials (discussed further below). Collectively, the volatilized gas, char, and leftover carbonaceous material (if any) define reactant carbon. Oxygen, fuel, and steam are introduced at a location in the system 10 downstream of the carbon feed subsystem 12. In the embodiment shown, oxygen, fuel, and steam are injected in a combustion zone 16. The fuel is introduced at arrow 17, the oxygen is introduced at arrow 19, optionally a mixture of steam and oxygen is introduced at an arrow 21, and the steam is added at arrow 23. The fuel and oxygen mix and react (i.e., combust) to form combustion byproducts (e.g., H₂O, carbon dioxide, carbon monoxide) and generate heat in the combustion zone 16 sufficient to react oxygen, steam, leftover fuel (if any), and reactant carbon in a syngas reaction to form syngas and syngas byproducts (e.g., solids) in a horizontal reaction zone 18. Collectively, the oxygen, fuel, steam, any volatilized gases, any gaseous combustion byproducts, and syngas define a mixture of gases. The syngas reaction is continued in a tortuous reaction zone 20 downstream of the horizontal reaction zone 18. At least a portion of the volatilization zone 14 and the tortuous reaction zone 20 are enclosed within a furnace 22 which is configured to maintain the temperatures of the volatilization zone 14 and the tortuous reaction zone 20 at a temperature sufficient to enable volatilization of gases from the carbonaceous material and the syngas reaction, respectively. The mixture of gases enter a residence chamber 24 in which syngas is separated from more dense materials, such as solids (e.g., ash, tar, etc.). In a quench zone 26, syngas is cooled and exits the system 10 at arrow 27 for collection. Embodiments of the present invention are designed to maintain the leftover fuel (if any), oxygen, steam, and reactant carbon at a temperature effective for syngas synthesis with less or no excess oxygen when compared to conventional syngas production systems (see discussion of furnace 22 below).

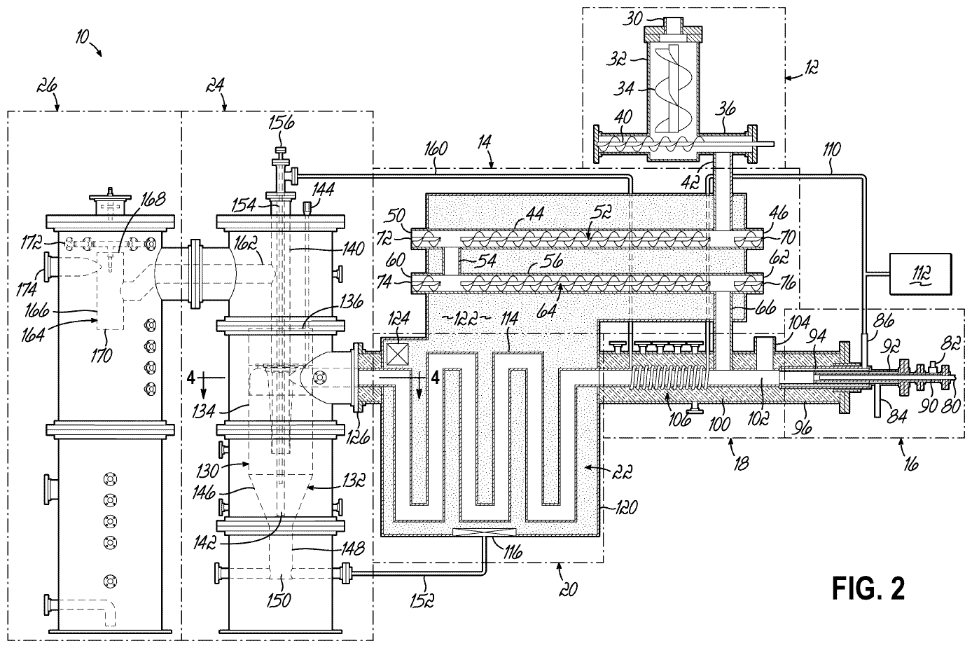

To those ends, further detail of the carbon feed subsystem 12, the volatilization zone 14, the combustion zone 16, the horizontal reaction zone 18, the residence chamber 24 and the quench zone 26 are described with reference to FIGS. 2-5. In the exemplary embodiment of FIG. 2, the carbon feed subsystem 12 includes a carbonaceous material inlet 30 which receives carbonaceous material small enough to maintain a turbulent gas-solids flow. In one such embodiment, the material has an average diameter sized between ¼ inch (approximately 6.35 mm) and ½ inch (approximately 12.7 mm). The carbonaceous material inlet 30 transfers the carbonaceous material to a vertical feed section 32. The vertical feed section 32 includes a vertical auger 34 which directs the carbonaceous material toward a horizontal feed section 36. The horizontal feed section 36 is configured to receive the carbonaceous material from the vertical feed section 32 and includes a horizontal auger 40 which directs the carbonaceous material toward a vertical conduit 42. The vertical conduit 42 connects the carbon feed subsystem 12 to the volatilization zone 14 and allows the volatilization zone 14 to receive the carbonaceous material. For example, under gravity, the carbonaceous material drops from the auger 40 into the volatilization zone 14. The carbonaceous material may be any material that includes carbon. By way of example and not limitation, the carbonaceous material may be one or a mixture of raw organic materials (e.g., wood, coal, oil shale, coal, compost, other biomass, etc.), refined organic materials (e.g., cellulose, hemicellulose(s), lignin, pectin, latex, starch, chitin, gelatin, collagen, etc.), synthetic carbonaceous materials, waste materials from other processes, other carbonaceous materials, or some combination thereof. Depending on the type of carbonaceous material used, undesirable products may be formed such as, for example, oils, sulfur, sulfuric acid, arsenic, or some combination thereof. In such embodiments, an optional condenser (not shown) may be used to separate at least a portion of the undesirable products formed prior to the horizontal reaction zone 18. In one such embodiment, the optional condenser (not shown) may be included between volatilization zone 14 and the horizontal reaction zone 18.

The volatilization zone 14 is adapted to heat the carbonaceous material from the carbon feed subsystem 12 to volatilize at least one gas from the carbonaceous material. The volatile gas may include, for example, hydrogen (H₂), carbon monoxide (CO), methane (CH₄), one or more non-combustible gases (e.g., nitrogen (N₂), carbon dioxide (CO₂), water vapor (H₂O), etc.), other carbonaceous gases (e.g., hydrocarbons), or some combination thereof. In one embodiment, the volatile gas includes hydrogen, carbon monoxide, methane, or a mixture thereof in which carbon monoxide and/or hydrogen gas is the majority by volume. By removing volatile gases from the carbonaceous material, at least part of the carbonaceous material may be converted to char. In the exemplary embodiment, the volatilization zone 14 volatilizes a majority of the gases from the carbonaceous material by controlling at least one of the residence time, temperature, and type of carbonaceous material used.

In the exemplary embodiment, the volatilization zone 14 includes two sections which transfer the carbonaceous material in a zig-zag pathway allowing the carbonaceous material to absorb heat so as to increase volatilization of gases from the carbonaceous material before reaching the horizontal reaction zone 18. For example, the zone 14 includes a first volatilization section 44 that has a first end 46 and a second end 50 opposite the first end 46. The first volatilization section 44 receives the carbonaceous material from the vertical conduit 42 proximate the first end 46 and moves the feed material from right to left in FIG. 2. In that regard, the horizontal volatilization section 44 includes an auger 52, which directs the carbonaceous material from the vertical conduit 42 toward a vertical conduit 54 that is proximate the second end 50. The auger 52 may be, for example, a conveyor belt, an auger, another similar means of conveying material horizontally, or some combination thereof. The vertical conduit 54 connects the first volatilization section 44 to a second volatilization section 56, allowing the second volatilization section 56 to receive the carbonaceous material under gravity from the auger 52. The second volatilization section 56 has a first end 60 and a second end 62 opposite the first end 60. The second volatilization section 56 receives the carbonaceous material proximate the first end 60 and moves the carbonaceous material from left to right in FIG. 2. In that regard, the second volatilization section 56 further includes an auger 64 which directs the carbonaceous material from the vertical conduit 54 toward a vertical conduit 66 proximate the second end 62. The auger 64 may be similar to the auger 52, for example, the auger 64 may be a conveyor belt, an auger, another similar means of conveying material horizontally, or some combination thereof. The vertical conduit 66 connects the volatilization zone 14 to the horizontal reaction zone 18 and enables the horizontal reaction zone 18 to receive the carbonaceous material, char, and/or the volatilized gas (collectively the reactant carbon).

The residence time of the carbonaceous material within the volatilization zone 14 may be selected or determined, at least in part, by selecting or determining the speed of one or both the augers 52, 64. In one embodiment, the residence time of the carbonaceous material within the volatilization zone 14 is between 0.75-15 minutes. In an alternate embodiment, the residence time of the carbonaceous material within the volatilization zone 14 is between 45-300 seconds. In an alternate embodiment, the residence time of the carbonaceous material within the volatilization zone 14 is between 5-15 minutes. Following the volatilization zone 14, the reactant carbon moves to the horizontal reaction zone 18. As shown in the exemplary embodiment, the leftover carbonaceous material (if any) and/or char may drop under the influence of gravity into the horizontal reaction zone 18.

The volatilization zone 14 may further include one or more optional retention augers 70, 72, 74, 76. The retention auger 70 is positioned proximate the first end 46 and the vertical conduit 42 and is configured to direct any carbonaceous material and/or char it receives to the auger 52. The retention auger 72 is positioned between the second end 50 and the auger 52 and is configured to direct any carbonaceous material and/or char it receives to the vertical conduit 54. The retention auger 74 is positioned between the first end 60 and the auger 64 and is configured to direct any carbonaceous material and/or char it receives to the auger 64. The retention auger 76 is positioned between the second end 62 and the auger 64 and is configured to direct any carbonaceous material it receives to the vertical conduit 66. As shown, the furnace 22 may be positioned such that the does not enclose the retention augers 70, 72, 74, 76. This may permit maintenance of the sections 44, 56, via one or both ends 46, 50 and/or 60, 62, respectively, such as to clean out or unplugging the augers without first gaining access to the interior of the furnace 22. However, in an alternate embodiment (not shown), the furnace encloses the retention augers 70, 72, 74, 76. In some embodiments, the retention augers 70, 72, 74, 76 provide structural support to the furnace 22. The retention augers 70, 72, 74, 76 may be, for example, a conveyor belt, an auger, another similar means of conveying material horizontally, or some combination thereof.

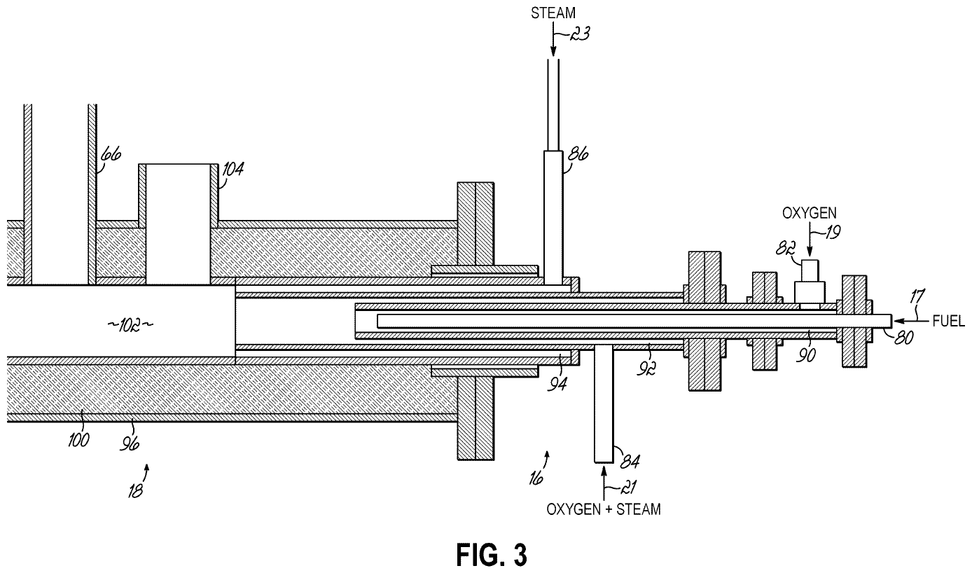

With reference to FIGS. 2 and 3, the combustion zone 16 is adapted combust the fuel with the oxygen to form combustion byproducts (e.g., H₂O, carbon dioxide, carbon monoxide) and provide heat to the horizontal reaction zone 18 in which the reactant carbon enters from the volatilization zone 14. Collectively, the fuel, oxygen, steam, any volatilized gases from the reactant carbon, any gaseous combustion byproducts, and syngas define a mixture of gases. To these ends, the combustion zone 16 includes a fuel inlet 80, an oxygen inlet 82, an optional oxygen steam inlet 84, and a steam inlet 86. In the exemplary embodiment, the oxygen inlet 82 leads to a concentric path 90 (FIG. 3) surrounding the fuel inlet 80 and opens to the horizontal reaction zone 18 distal from the outlet of the fuel inlet 80. In one embodiment including the optional oxygen steam inlet 84, the oxygen steam inlet 84 leads to an optional concentric path 92 surrounding at least a portion of the concentric path 90 and/or the fuel inlet 80 and opens to the horizontal reaction zone 18. In one embodiment, the steam inlet 86 leads to a concentric path 94 that surrounds at least a portion of the optional concentric path 92, the concentric path 90, and/or the fuel inlet 80. One or more of the concentric paths 90, 94 and/or the optional concentric path 92 may be machined or rifled to promote swirling of the gases as they are conveyed toward the horizontal reaction zone 18.

By way of example, fuel such as syngas, propane, natural gas, or some combination thereof, may be introduced through the fuel inlet 80 of the combustion zone 16 at arrow 17 and, at the same time, oxygen is added at the oxygen inlet 82 at arrow 19 so that combustion occurs at the combustion zone 16. Any oxygen added beyond what is needed to achieve stoichiometric combustion of fuel and oxygen defines excess oxygen. In one embodiment, the amount of excess oxygen included is less than or equal to 10% of the amount of oxygen included for the stoichiometric combustion. The combination of fuel and oxygen will react (i.e., combust) to generate the heat necessary to cause the third and fourth gasification reactions, which can be understood collectively as reacting the reactant carbon and water in a stoichiometric endothermic reaction to form hydrogen gas and carbon monoxide. The excess oxygen may also react with the reactant carbon to form at least one of the carbon monoxide and carbon dioxide as shown in the first and second gasification reactions. Depending on the relative molar concentration of excess oxygen to the reactant carbon, the balance between formation of carbon monoxide and carbon dioxide may shift, with a lower molar ratio of oxygen to carbon generally leading to a higher percentage of carbon monoxide formed instead of carbon dioxide (i.e., a sub-stoichiometric reaction between the reactant carbon and excess oxygen generally produces more carbon monoxide). The sub-stoichiometric reaction of the reactant carbon with any excess oxygen may involve a molar ratio between the excess oxygen atoms and reactant carbon atoms less than or equal to 1:1, alternatively less than or equal to 0.5:1, or still alternatively less than or equal to 0.1:1 after the combustion zone 16. In one embodiment, the ratio of excess oxygen to reactant carbon is selected to produce a syngas having a desired molar ratio between hydrogen and carbon monoxide in the horizontal reaction zone 18. In one embodiment, the combustion zone 16 temperature is at least 1300° F. In an alternate embodiment, the combustion zone 16 is kept at a temperature range of 1900° F. to 2300° F. In yet another alternate embodiment, the combustion zone 16 is kept at a temperature greater than or equal to 2350° F.

A blend of oxygen and steam may optionally be introduced from the optional oxygen steam inlet 84 at arrow 21. In such embodiments, the heat from combustion may react the additional oxygen introduced at optional oxygen steam inlet 84 with leftover fuel (if any) introduced at inlet 80 to generate heat. This reaction raises the temperature of the steam introduced at optional oxygen steam inlet 84 enabling steam to react with the reactant carbon in a horizontal reaction area 102 within the horizontal reaction zone 18 (discussed further below). Steam is introduced from the steam inlet 86 at arrow 23 to react with the reactant carbon in the horizontal reaction zone 18. By way of example, unreacted fuel, if any, from the fuel inlet 80, excess oxygen, if any, from the oxygen inlet 82 and optionally from the optional oxygen steam inlet 84, the steam from the steam inlet 86 and optionally from the optional oxygen steam inlet 84, and the reactant carbon from the volatilization zone 14 may react in the horizontal reaction zone 18 to form syngas and syngas byproducts (e.g., solids such as ash, tar, etc.). Syngas formed during this reaction is added to the mixture of gases as set out above. The combustion of fuel and oxygen increases the temperature of the unreacted fuel (if any), excess oxygen (if any), steam, and reactant carbon during the syngas reaction immediately downstream of the stoichiometric combustion in the combustion zone 16 and promotes the formation of carbon monoxide and/or hydrogen over carbon dioxide in the syngas reaction.

With reference to FIGS. 2 and 3, the mixture of gases and reactant carbon from the volatilization zone 14 is deposited immediately downstream from the combustion zone 16 into the horizontal reaction zone 18. The horizontal reaction zone 18 includes a steel casing 96 and a refractory liner 100 that defines a horizontal reaction area 102. The horizontal reaction zone 18 further includes an access port 104 between the vertical conduit 66 and the combustion zone 16. Downstream from the vertical conduit 66, a superheater or heat exchanger 106 containing water and/or steam is used to maintain the temperature in the horizontal reaction area 102 at or above a predetermined temperature threshold. As shown in FIG. 2, the heat exchanger 106 is a self-contained coil that surrounds a portion of the horizontal reaction area 102 and is in thermal communication with the horizontal reaction area 102 without being in material communication with the horizontal reaction area 102. The water and/or steam used in the heat exchanger 106 reduces wasted heat from the residence chamber 24 (discussed further below) by transferring at least some of the heat from syngas leaving the residence chamber 24 (discussed further below) that would otherwise be wasted to the horizontal reaction area 102. In one such embodiment, using the heat exchanger 106 enables a reduction in oxygen that may otherwise be used to maintain the temperature of the horizontal reaction area 102 at a predetermined temperature range or above a predetermined temperature threshold. Water and/or steam leaving the heat exchanger 106 may then sent through a pathway 110 to be used at a pneumatic steam eductor 112. In one embodiment, the pneumatic steam eductor 112 conveys the steam through the steam inlet 86 as discussed above. In another embodiment, the steam eductor 112 conveys the steam into a different portion of the combustion zone 16, such as the optional oxygen steam inlet 84 (not shown).

The width and length of the horizontal reaction zone 18 may be selected based on at least one of the feed rate of the reactant carbon from the volatilization zone 14, the capacity to generate the requisite heat for the syngas reaction in the horizontal reaction area 102, desired residence time of the mixture of gases within the horizontal reaction area 102, and desired velocity of the mixture of gases through the horizontal reaction area 102. In one embodiment, the length and width of the horizontal reaction zone 18 are be selected so that the mixture of gases travel through the horizontal reaction area 102 at a speed between 500 ft/sec and 3,000 ft/sec. In one embodiment, the length and width of the horizontal reaction zone 18 are selected so that the mixture of gases resides within the horizontal reaction area 102 for a duration between 0.1 second and 0.3 seconds.

The horizontal reaction area 102 may be kept at a temperature sufficient to enable conversion of the mixture of gases and reactant carbon to syngas. By way of example, the horizontal reaction area 102 is kept at a temperature greater than or equal to 700° F. and less than or equal to 3,000° F. By way of further example, the horizontal reaction area 102 is kept at a temperature greater than or equal to 1,200° F. and less than or equal to 2,300° F. keeping the temperature just below the ash melting point when mixed feedstocks are used to prevent clinkers (i.e., solid byproducts such as ash) from forming. As yet another example, the horizontal reaction area 102 is kept at a temperature of greater than or equal to 1,900° F. and less than or equal to 2,100° F. In some embodiments, the horizontal reaction area 102 is kept at a sufficiently high temperature so that any ash that is formed or remains from the char is melted. The temperature of the horizontal reaction area 102 may be determined or selected, at least in part, by increasing the amount of excess oxygen, using the heat exchanger 106, modifying the temperature in volatilization zone 14, or some combination thereof.

The pressure in the horizontal reaction zone 18 may be maintained at a desired level using any conventional means of moderating pressure. For example, venting, changing the total volume of mass entering the system, other suitable pressure increasing and decreasing techniques, or some combination thereof may be utilized. In one embodiment, the pressure in the horizontal reaction area 102 is greater than or equal to atmospheric pressure but less than or equal to 1,000 psig. In some embodiments, pressure is not a determining factor in the reactor but rather is incidental to reaction conditions.

In FIG. 2, the mixtures of gases from the horizontal reaction zone 18 are sent downstream to the tortuous reaction zone 20. As shown, a majority of the tortuous reaction zone 20 may reside within the furnace 22. The tortuous reaction zone 20 includes a pathway 114 between the horizontal reaction zone 18 and the residence chamber 24. As shown, the pathway 114 is nonlinear between the zone 18 and the chamber 24. In the exemplary embodiment, the pathway 114 has a path length greater than the shortest possible distance between the horizontal reaction zone 18 and the residence chamber 24. The path length of the pathway 114 is designed to increase the residence time of the gas within the tortuous reaction zone 20 by, at least in part, increasing the average distance the mixture of gases travels. As shown in FIG. 2, the pathway 114 has a serpentine path shape within the furnace 22. However, other embodiments of the tortuous reaction zone 20 may include a pathway 114 having a different path shape such as, for example, a corkscrew path shape, a zig zag path shape, any other suitable tortuous path shape that increases the residence time or distance traveled in the tortuous reaction zone for the mixture of gases, or a mixture thereof (not shown). By way of example and not limitation, the path length of pathway 114 may be between 40 feet and 400 feet, alternatively between 100 feet and 200 feet, and still alternatively between 130 feet and 140 feet. In one embodiment, the total size and length of the pathway 114 is determined by, at least in part, the carbonaceous feed stock material (material) such as tires or wood, material volume, material size, mass of the total volume, the temperature of the carbonaceous feed stock material, the temperature of the pathway 114, or some combination thereof.

From a different perspective, the gas velocity along the pathway 114 determines the residence time between the horizontal reaction zone 18 and the residence chamber 24. For example, the mixture of gases may travel through the pathway 114 at a speed greater than or equal to 500 ft/sec and less than or equal to 3000 ft/sec, or alternatively at a speed greater than or equal to 1000 ft/sec and less than or equal to 2000 ft/sec. In one embodiment, the mixture of gases may travel through the pathway 114 at a speed sufficient to the keep a heaver material, such as ash or tar, suspended within the mixture of gases such that the heavier material reaches the residence chamber 24. Further in that regard, the mixture of gases may have a residence time within the tortuous reaction zone 20 between 0.056 and 0.14 seconds, or alternatively between 0.05 and 0.07 seconds, or still alternatively between 0.10 seconds and 0.15 seconds. In one embodiment, these residence times are selected by, at least in part, the reaction time needed, the velocity needed to achieve that reaction time, the mass of the reactant carbon, the size of the reactant carbon, or some combination thereof.

As shown, the furnace 22 may enclose and be in thermal communication with at least a portion of the volatilization zone 14 and/or at least a portion of the tortuous reaction zone 20 without being in material communication with the volatilization sections 44, 56, the vertical conduits 42, 54, 66, or the pathway 114. The furnace 22 includes a burner 116 and may be configured, as shown in FIG. 2, to enclose at least a portion of the volatilization zone 14 and/or the tortuous reaction zone 20 within an exterior wall 120 to define a heated volume 122. In one such embodiment, a majority of both the volatilization sections 44, 56, the vertical conduits 42, 54, 66, and the pathway 114 are located in the heated volume 122 of the furnace 22 and are in thermal communication therewith. In an embodiment not shown, only the volatilization zone 14 is located within the heated volume 122 and in thermal communication therewith. In another alternate embodiment not shown here, only the tortuous reaction zone 20 is located within the heated volume 122 and in thermal communication therewith.

The burner 116 is configured to add heat to the heated volume 122. In one embodiment thereof, the burner 116 is configured to heat at least one gas, for example, air, nitrogen, argon, some other gas, or some combination thereof within the heated volume 122. In a further embodiment thereof, an optional fan 124 is housed within the heated volume 122 and circulates heated gases throughout the heated volume 122. Although optional fan 124 is shown in a given position, it should be understood that optional fan 124 may be included at another position where it is able to circulate air within the heated volume 122. Although not shown, it should be understood that embodiments of the invention may include another medium in addition to the at least one gas within the heated volume 122 that is thermally conductive such as, for example, metals (e.g., copper, iron, aluminum, etc.), metal coils, other thermally conductive materials, or some combination thereof. For example, there may be one or more metal coils connected to the furnace 22 and proximate at least one of the volatilization zone 14 and/or the tortuous reaction zone 20 that conduct heat from the furnace to the air surrounding at least one of the volatilization zone 14 and/or the tortuous reaction zone 20 more rapidly (not shown).

As the furnace 22 heats the volatilization zone 14 and/or the tortuous reaction zone 20, volatilization and/or syngas formation may increase. Without being bound by theory, heating the volatilization zone 14 may increase volatilization of the carbonaceous material by heating the carbonaceous material within one or more sections within the volatilization zone 14, such as in the volatilization sections 44, 56 and the vertical conduits 42, 54, 66. Additionally, heating the reaction zone 20 may increase conversion of the mixture of gases and reactant carbon to syngas by heating the mixture of gases and the reactant carbon within pathway 114. By way of example, the heated volume 122 may be maintained at a temperature between 700° F. and 3,000° F., by way of additional example between 1,200° F. and 2,300° F., and by way of yet another example between 1,900° F. and 2,100° F. In embodiments of the present invention, the excess of oxygen added to the combustion zone 16 can be reduced or eliminated due, at least in part, to the heat provided to the mixture of gases within tortuous reaction zone 20 by the burner 116 within the furnace 22. In one such embodiment, the amount of excess oxygen added at or near the combustion zone 16 is reduced without adversely impacting the generation of syngas using the method or system 10. In another such embodiment, the amount of excess oxygen added at or near the combustion zone 16 is reduced which in turn reduces the amount of carbon dioxide produced using the system or method 10. In one embodiment, the excess oxygen added at the combustion zone 16 is eliminated. In an alternate embodiment, the excess oxygen is included in an amount having a molar ratio of the excess oxygen atoms to the carbon atoms of the carbonaceous material of 0.1:1.

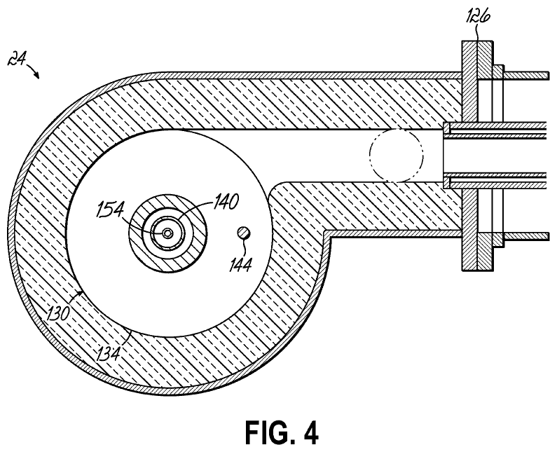

With reference to FIGS. 2 and 4, a distal end 126 of the pathway 114 is connected to the residence chamber 24. The residence chamber 24 receives the mixture of gases (including syngas), any reactant carbon, any combustion byproducts, any syngas byproducts, and maintains the system at a temperature sufficient to complete the syngas reaction. In one embodiment, the temperature of the residence chamber 24 is maintained above 1,000° F. In a further embodiment, the temperature of the residence chamber 24 maintained between 1300° F. (i.e., above the Boudouard carbon formation temperature) and 2100° F. Additionally, the residence chamber 24 is configured to separate out denser components (e.g., solid byproducts from the combustion reaction and/or the syngas reaction) from the mixture of gases.

In the exemplary embodiment, the residence chamber 24 has a top portion 130 and a bottom portion 132. The top portion 130 has a sidewall 134 and a closed top 136. In one embodiment, the top portion 130 is cylindrical and the sidewall 134 is a matching cylindrical wall. However, embodiments of the invention are not limited to the volumetric shape of the chamber 24. The sidewall 134 and/or the closed top 136 may include a steel casing and a refractory lining. The residence chamber 24 further includes a gas outlet tube 140 that includes an opening 142 and extends through the closed top 136 in a center of the residence chamber 24. As shown, the opening 142 is positioned within the bottom portion 132 of the chamber 24 and is configured to receive the mixture of gases from the zone 20 that are travelling toward the quench zone 26. Alternatively, and although not shown, the opening 142 may be positioned within the top portion 130. An optional test port inlet 144 can be included extending through the closed top 136 into the center of the residence chamber 24. The optional test port 144 may extend proximate the distal end 126. With regard to the bottom portion 132, the bottom portion 132 includes a tapered sidewall 146 that extends from the sidewall 134 to define a bottom outlet 148. The outlet 148 is in communication with the recovery tank 150. In one embodiment, the bottom portion 132 is frustoconical and the tapered sidewall 146 is a matching frustoconical wall. However, embodiments of the invention are not limited to the volumetric shape of the chamber 24.

As shown in FIGS. 1 and 3, the distal end 126 of the pathway 114 is connected to top portion 130 of the residence chamber 24 such that the distal end 126 and the cylindrical wall 134 are aligned substantially tangentially. Due at least in part to this substantially tangential alignment between the distal end 126 and the cylindrical wall 134, the gas entering the residence chamber 24 from the tortuous reaction zone 20 swirls around the residence chamber 24. As gas enters the residence chamber 24 from the distal end 126, the swirling gas is forced downwardly toward the bottom portion 132. In one embodiment, the mixture of gases reaching the bottom portion 132 are collected in the gas outlet tube 140 at the opening 142. The denser material formed in the reaction that reaches the bottom portion 132, such as ash (e.g., a solid material) and other useful byproducts, will continue downwardly into the recovery tank 150.

In one embodiment, the ash and other combustible byproducts are sent to the burner 116 via pathway 152 as fuel to be combusted to heat the heated volume 122. Additionally or alternatively, any non-combustible byproducts, for example, metal, ceramics fused ash, are separated from the combustible byproducts and collected. In one embodiment, the recovery tank 150 contains water to quench the ash and other useful byproducts.

In one embodiment, the residence chamber 24 is maintained at an elevated temperature above 1,000° F. The elevated temperature may help increase the conversion of reactant gases to syngas. Accordingly, by the time that the mixture of gases reaches the bottom portion 132, syngas may account for between 10% and 70% of the mixture of gases. In an alternate embodiment, the syngas may account for between 10% and 30% of the mixture of gases. In a still alternate embodiment, the syngas may account for between 60% and 70% of the mixture of gases. Additionally, in embodiments in which enclosing the tortuous reaction zone 20 within the heated volume 122 allows excess oxygen to be reduced, less undesired byproducts may be formed. In one embodiment, the unwanted byproducts account for between 5% and 15% of the mixture of gases. In an alternate embodiment, the unwanted byproducts account for between 5% and 10% of the mixture of gases. In a still alternate embodiment, the unwanted byproducts account for between 10% and 15% of the mixture of gases. By way of comparison, it is believed that in conventional systems, these unwanted byproducts may account for between 20% and 50% of the mixture of gases.

With reference to FIG. 2, within the gas outlet tube 140 is a heat exchanger 154 which is connected to and in material communication with a water pump 156. It should be understood that the water pump 156 may supply water to the heat exchanger 154 in liquid form or in gaseous form depending on the source of water. The water pump 156 may be connected to a downstream exothermic process (not shown) such that the water pump 154 is configured to receive steam from the downstream exothermic process. The heat exchanger 154 is in thermal communication with the gas that travels through the gas outlet tube 140 toward the quench zone 26. In one embodiment, the heat exchanger 154 is concentric with the gas outlet tube 140. The heat exchanger 154 may be further configured to have a 180° bend proximate the opening 142 such that water/steam travels from the water pump 156 down toward the opening 142, but not necessarily reaching the opening 142, and then up toward the water pump 156, but not necessarily reaching the water pump 156. In one such embodiment, after the 180° bend, the water/steam then is directed to a pathway 160 connecting the heat exchanger 154 to the heat exchanger 106. The pathway 160 may have a portion that travels through the furnace 22 such that it is in thermal communication, but not material communication, with the heated volume 122. In another embodiment, the pathway 160 is kept apart from the furnace 22. As discussed above, the water/steam from the heat exchanger 106 may travel along a pathway 110 towards a steam eductor 112. In one embodiment, as shown, a portion of the pathway 110 travels through the furnace 22 such that it is in thermal communication, but not material communication, with the heated volume 122.

The gas outlet tube 140 is fluidly coupled with a pathway 162 that connects the residence chamber 24 to the quench zone 26. The quench zone 26 is configured to receive the syngas from the residence chamber 24. As shown, the pathway 162 is in material communication with a quench chamber 164 within the quench zone 26. The quench chamber 164 has at least one sidewall 166, a closed top 168, and a closed bottom 170. In one embodiment, the at least one sidewall 166 is a cylindrical sidewall. However, embodiments of the invention are not limited to the configuration of the sidewall 166, top 168, or bottom 170. In one embodiment, the at least one sidewall 166, the closed top 168, and/or the closed bottom 170 include a steel casing and a refractory lining.

With continued reference to FIG. 2, the quench zone 26 is configured to rapidly cool the syngas to a temperature at or below 100° F. In one embodiment, the quench zone 26 includes a quench water pump 172 to control the heat and space within the quench chamber 164 by adding an amount of water to the quench zone 26. In one embodiment, the amount of water added to the quench chamber 164 is determined based on at least one of the volume of the syngas and the excess heat of the syngas. Once cooled, the excess syngas travels to a syngas exit 174 where the different product gases, for example, hydrogen, methane, and carbon dioxide, are captured and/or are utilized.

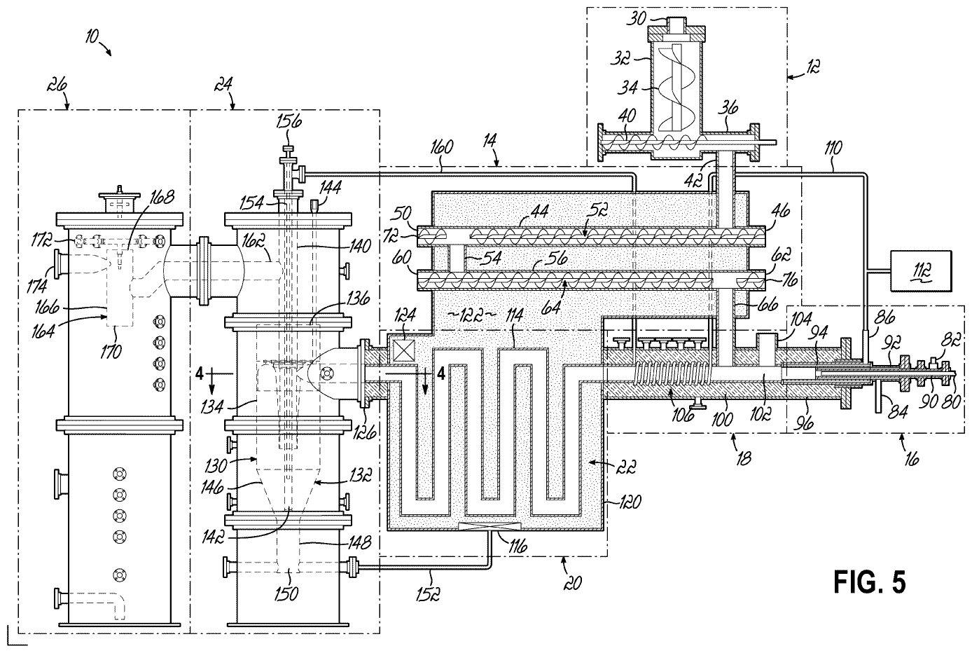

With reference to FIG. 5, an alternate embodiment of the volatilization zone 14 is shown. Unless otherwise stated, the system 10 and volatilization zone 14 in FIG. 5 may contain similar or the same components as stated in the description of FIG. 2. As shown in FIG. 5, the retention augers 70 and 74 from FIG. 2 are not included. Instead, the auger 52 extends from the first end 46 towards the vertical conduit 54. Similarly, the auger 64 extends from the first end 60 towards the vertical conduit 64. In some such embodiments, the augers 52 and 64 may provide structural support to the furnace 22.

In one embodiment, syngas formation may be improved by, at least in part, producing a syngas meeting one or more requirements selected from the group consisting of having an amount of hydrogen and carbon monoxide collectively between 40-80%, having an amount of an amount of carbon dioxide less than or equal to 25%, having an amount of hydrocarbons less than or equal to 5% by volume of the syngas, and having a ratio of hydrogen to carbon monoxide of greater than or equal to 2:1. In one embodiment, syngas formation may be improved by, at least in part, producing a syngas having an amount of carbon monoxide and hydrogen collectively between 40-80% by volume of the syngas, alternatively between 40-50%, or still alternatively between 70-80%.

In an alternate embodiment, syngas formation may be improved by, at least in part, producing a syngas having an amount of carbon dioxide less than or equal to 25% by volume of the syngas, or alternatively less than or equal to 10% by volume of the syngas. In an alternate embodiment, syngas formation may be improved by, at least in part, producing a syngas having an amount of carbon dioxide between 1-25%, alternatively between 1-10%, or still alternatively between 15-25%.

In another alternate embodiment, syngas production may be improved by, at least in part, producing a syngas having an amount of hydrocarbons less than or equal to 10% by volume of the syngas, or alternatively less than or equal to 5%.

In yet another alternate embodiment, syngas formation may be improved by, at least in part, producing a syngas having a molar ratio of hydrogen to carbon monoxide greater than or equal to 1:1, alternatively greater than or equal to 2:1, or still alternatively greater than or equal to 3:1.

The amount of hydrogen and carbon monoxide collectively formed during the syngas reaction may be modified by changing the amount of excess oxygen added to the system and/or by otherwise modifying the temperature of the syngas reaction in the system 10. In one such embodiment, the amount of excess oxygen added to the system, when compared to the amount of oxygen necessary for stoichiometric combustion of the amount of fuel, is less than or equal to 30% (i.e., less than or equal to a 0.3:1 ratio), alternatively less than or equal to 10% (i.e., less than or equal to a 0.1:1 ratio), or still alternatively less than or equal to 1% (i.e., less than or equal to a 0.01:1 ratio). In one embodiment, no excess oxygen is added beyond what is needed for stoichiometric combustion of the amount of fuel.

The one or more downstream systems may be configured to receive the syngas formed using system 10 (not shown). In one such embodiment, a downstream system configured to implement a Fischer-Tropsch reaction using syngas as a reagent is configured to receive the syngas from system 10. In another such embodiment, a downstream system configured to implement a MTG reaction using syngas as a reagent is configured to receive the syngas from system 10. In embodiments where the downstream system is configured to implement an exothermic reaction, such as Fischer-Tropsch reaction (7) and MTG reactions (8)-(9), heat produced in the downstream system may be recycled to the system 10. In one such embodiment, heat produced from an exothermic reaction in a downstream system is recycled to the system 10 at one or more points selected from the list consisting of the volatilization zone 14, the combustion nozzle 16, the horizontal reaction zone 18, the tortuous reaction zone 20, and the furnace 22. Additionally or alternatively, a byproduct of heat generated in an exothermic reaction, such as steam generated using the syngas in a downstream system implementing the Fischer-Tropsch reaction (7) or the MTG reaction (9), may be recycled to the system 10. By way of example and not limitation, steam may be recycled to one or more points of the system 10 selected from the list consisting of the water pump 156, the oxygen steam inlet 84, and the steam inlet 86. Recycling heat and/or a byproduct of heat (e.g., steam) from one or more downstream system(s) configured to use syngas as a reagent in an exothermic reaction to the system 10 may reduce or eliminate the use of excess oxygen in the syngas formation reaction.

While the present invention has been illustrated by the description of one or more embodiments thereof, and while the embodiments have been described in considerable detail, they are not intended to restrict or in any way limit the scope of the appended claims to such detail. The various features shown and described herein may be used alone or in any combination. Additional advantages and modifications will readily appear to those skilled in the art. The invention in its broader aspects is therefore not limited to the specific details, representative apparatus and methods and illustrative examples shown and described. Accordingly, departures may be made from such details without departing from the scope or spirit of Applicants' general inventive concept.

1. A system for forming syngas comprising:
a volatilization zone configured to receive a carbonaceous material and heat the carbonaceous material to a temperature effective to volatilize gas from the carbonaceous material;
a combustion zone downstream of the volatilization zone and configured to be coupled to a source of fuel, a source of oxygen, and a source of steam and to combust fuel with oxygen to produce heat;
a horizontal reaction zone downstream from the combustion zone and configured to react steam from the source of steam and the volatilized gas to produce syngas;
a tortuous reaction zone downstream from the horizontal reaction zone and configured to receive and react steam and volatilized gas to produce syngas; and
a furnace including an exterior wall that defines a heated volume,
wherein at least a portion of the tortuous reaction zone is within the heated volume.

2. The system of claim 1, wherein at least a portion of the volatilization zone is within the heated volume.

3. The system of claim 1, wherein the tortuous reaction zone has a path length greater than or equal to 40 feet and less than or equal to 400 feet.

4. The system of claim 1, wherein the furnace is kept at a temperature greater than or equal to 1,900° F. and less than or equal to 2,300° F.

5. The system of claim 1, wherein the furnace further comprises a fan configured to circulate air within the externally heated area.

6. The system of claim 1, further comprising:
a carbon feed system having an inlet, being upstream from the volatilization zone, and being configured to receive the carbonaceous material in the inlet and convey the carbonaceous material to the volatilization zone.

7. The system of claim 1, further comprising:
a residence chamber downstream from the tortuous reaction zone and configured to receive the syngas, steam, volatilized gas, combusted fuel, and oxygen and separate the syngas from at least one byproduct formed during the syngas reaction;
a recovery tank configured to receive the at least one byproduct; and
a quench zone downstream from and in material communication with the residence chamber, wherein the quench zone is configured to cool the syngas for removal from the system.

8. The system of claim 7, further comprising:
a pathway connecting the recovery tank to the furnace, wherein the furnace is configured to receive the at least one byproduct to use as fuel to heat the heated volume.

9. The system of claim 8, wherein the at least one byproduct comprises a material selected from the group consisting of ash and char.

10. The system of claim 7, further comprising:
a heat exchanger configured to receive water and/or steam and remove heat from the syngas, wherein the heat exchanger is in thermal communication but not material communication with at least one of the residence chamber, the horizontal reaction zone, and the heated volume.

11. The system of claim 10, wherein the heat exchanger is configured to supply at least a portion of the steam used in the syngas reaction to the combustion zone.

12. A method for producing syngas comprising:
heating a carbonaceous material to a temperature effective to volatilize a gas therefrom;
combusting a mixture of fuel and oxygen to generate heat;
heating a mixture of steam and the volatilized gas with the heat from combusting in a reaction area to form syngas; and
flowing the mixture of steam and the volatilized gas from the reaction area along a non-linear pathway from the reaction area toward a recovery tank at which syngas is collected,
wherein during flowing along the non-linear pathway, heating the mixture of steam and the volatilized gas to a temperature effective to form additional syngas.

13. The method of claim 12, wherein the nonlinear pathway has a path length greater than or equal to 40 feet and less than or equal to 400 feet.

14. The method of claim 12, wherein the mixture of steam and the volatilized gas within the reaction area and the nonlinear pathway is kept at a temperature greater than or equal to 1,900° F. and less than or equal to 2,300° F.

15. The method of claim 12, further comprising:
quenching the syngas and the additional syngas for removal.

16. The method of claim 15 wherein the syngas and the additional syngas are maintained at a temperature above the Boudouard carbon formation range prior to quenching.

17. The method of claim 12 further comprising:
capturing heat from at least one of the syngas and the additional syngas; and
using the captured heat to heat an area where at least one of the syngas or the additional syngas is formed without being in material communication with the area.

18. The method of claim 12, further comprising:
capturing at least one byproduct formed during the syngas reaction; and
burning the at least one byproduct to produce heat for use during flowing of the steam and the volatilized gas.

19. The method of claim 18, wherein the at least one byproduct includes a material selected from the group consisting of ash and char.

20.-27. (canceled)

28. A method for producing syngas in the system of claim 1, the method comprising:
heating a carbonaceous material to a temperature effective to volatilize a gas therefrom in the volatilization zone;
combusting a mixture of fuel and oxygen to generate heat in the combustion zone;
heating a mixture of steam and the volatilized gas with the heat from combusting in the horizontal reaction zone to form syngas; and
flowing the mixture of steam and the volatilized gas from the horizontal reaction zone along a non-linear pathway in the tortuous reaction zone from the horizontal reaction zone toward a recovery tank at which syngas is collected,
wherein during flowing along the non-linear pathway, in the furnace, heating the mixture of steam and the volatilized gas to a temperature effective to form additional syngas.
